(19) United States
(12) Patent Application Publication
(10) Pub. No.: US 2017/0289127 A1
(43) Pub. Date: Oct. 5, 2017

(54) SMART DATA CARDS THAT ENABLE THE PERFORMANCE OF VARIOUS FUNCTIONS UPON ACTIVATION/AUTHENTICATION BY A USER'S FINGERPRINT, ONCARD PIN NUMBER ENTRY, AND/OR BY FACIAL RECOGNITION OF THE USER, OR BY FACIAL RECOGNITION OF A USER ALONE, INCLUDING AN AUTOMATED CHANGING SECURITY NUMBER THAT IS DISPLAYED ON A SCREEN ON A CARD'S SURFACE FOLLOWING AN AUTHENTICATED BIOMETRIC MATCH

(71) Applicant: Chaya Coleena Hendrick, Las Vegas, NV (US)

(72) Inventor: Chaya Coleena Hendrick, Las Vegas, NV (US)

(21) Appl. No.: 15/083,618

(22) Filed: Mar. 29, 2016

(51) Int. Cl. H04L 29/06; H04W 12/06; G06K 9/00; G06K 19/07

(52) U.S. Cl. CPC H04L 63/083; G06K 19/0704; H04L 63/0861; H04W 12/06; G06K 9/00087; G06K 9/00288

(57) ABSTRACT

A smart card such as an EMV card that connects, wirelessly or by contact, to a reader or other device, and permits the flow of information/data to/from the card when connected thereto, after fingerprint scanning authorization/user verification system; or image scanning authorization/user verification, or PIN number entry from an on-card pad, or both, including a display screen for displaying changing/static user identification data stored thereon/therein alter such authorization/verification.

This application is a continuation-in-part application of U.S. patent application Ser. No. 14/672,488 filed on Mar. 30, 2015, and relates to two U.S. patent applications Ser. No. 13/445,608, filed Apr. 12, 2012, and Ser. No. 13/762,099, filed Feb. 7, 2013, in the United States Patent and Trademark Office. We hereby incorporate here by reference those entire applications as though fully set forth here.

This invention relates to smart data cards such as EMV contact or contactless debit and credit cards, or other memory devices such as a banking, debit, or credit card, an access control card, an identity card, or a licensing card, that requires activation or authentication before use. Such activation or authentication may take place upon facial recognition, as with a small camera in/on the card, or upon both facial recognition and fingerprint recognition or entering a Personal Identification Number (“PIN”) passcode utilizing, e.g. an on-board nine-number numeric keypad. This card may be inserted into, or otherwise connected, e.g. wirelessly, to a reader, or to a connector device, or to a portable computing device such as an iPhone or an iPad, or to other smart phones, and computing pads. NFC transmission to an NFC card reader and may also turn on a digital display that reveals a card owner's CVV number. The CVV number digital display will be on the reverse of the card.

Fingerprint authentication/activation may be effected as follows: 1. a user touches a fingerprint scanning sensor on the surface of one or more of these devices; 2. the sensor transmits fingerprint data to an internal processor and memory of one or more of the devices; and 3. the user's fingerprint is compared to one or more stored fingerprint databases in one or more of these cards/devices. If comparison produces a match between the sensed fingerprint and a stored fingerprint, activation/authentication occurs.

PIN authentication/activation may be effected as follows: 1. a user enters his/her PIN number via the on-board keypad; 2. the pad transmits data to an internal processor and memory of one or more of the devices; and 3. the PIN number entered is compared to one or more stored PIN number databases in one or more of these cards/devices. If comparison produces a match between the inputted PIN number and a stored PIN number, activation/authentication occurs.

These cards may include memory or other storage for a photograph/image of a person or another image. The card may include an attached camera or a built-in camera to capture such an image. An image of a person or something else may be taken with the computing device's camera. This newly-taken image is processed by software on a card reader, and tested for matching with previously-stored images on a card or other storage medium. Computer coding may control such testing, e.g., photographic recognition software.

For multi-factor match/authentication/verification, a fingerprint scanner may be in/on a card. A user touches a sensor on such a card to read a person's fingerprint, followed by comparison with previously-stored fingerprints. The same user may also undergo picture capture and matching, or keypad PIN number activation/authorization, or fingerprint, picture, and/or PIN number are compared with stored fingerprints, stored pictures, and/or PIN number. If a match of fingerprint, picture, and/or PIN number occurs, then prescribed functions may be activated/authenticated for the card. Alternatively, in a single-factor match/verification, only a photograph or pin number match may be required.

Another match/authentication/verification method for use with fingerprint or image verification may use voice pattern recognition. A voice pattern recording is made by each communication participant for use as an encryption key. All participants sign on to a voice session, and a voice pattern may be captured of such participants with the repeating of a variable revolving computer generated sentence. Next, all participants enter a computer generated code. The resulting code keys may be used as voice scramble/unscramble keys. Interception of these keys by others would deliver an unrecognizable message.

These cards may include an internal memory for storage of images and text, or a PIN number or of a user's fingerprint. Such fingerprints, images and/or PIN numbers may also be stored in memory connected to the device's internal processor. Such memories may have a capacity of at least about one gigabyte for information and data storage, display and transmission. Such data/information may be downloaded to such cards wirelessly, or through contact pads on the cards that are connected to such memories. Such cards may also include wireless transceivers connected to antennas in/on the cards.

Upon initial activation of such devices, a user may be prompted, as by a digital display on such a device's display screen, enter a PIN number, or to swipe their finger over the device's fingerprint sensor. So doing captures/stores the person's PIN number or fingerprint in the device's internal memory, and may preclude capturing/storing any other PIN number or fingerprint unless the stored PIN or fingerprint is removed. Alternatively, such a device may prompt for two separate fingerprints, which can each separately activate the same or different functions of the card. After capture/storage of one or more fingerprints or PIN number, a user may be prompted to insert such a device into a computer/computing device, USB port or adaptor, causing a device manager to appear on the screen. A user may then be prompted to input information to the device manager. Such information may then be stored in such a card's internal memory.

In some embodiments, a contactless transaction card, e.g. a banking/credit/debit card, bearing an RFID or other wireless chip, is moved near to an RFID or other wireless reader to read the card's data. In other embodiments, a card may be read by insertion of the card into a connector device. In some card embodiments, user authentication/verification permits such card reading to take place. Insertion causes contact between a surface-mounted device, e.g. chip on the card, and reading contacts inside the connector device.

A number, usually including three or four digits, is used on payment cards such as credit and debit cards, often with one or more other card-identifying features such as a password, personal identification number (PIN), and a sequence of numbers, sometimes called a primary account number or card identification number (CID or PAN), usually displayed on the front of such cards. The multi-digit number, e.g., a CVV number, may be found on the back or front of such cards. American Express cards, for example, include a four digit number (CID) on the front of the card. Often, a CVV number is printed, not embossed, on the signature strip on the back of the card. Some North American MasterCard and Visa cards carry CVV numbers in a separate panel to the right of the signature strip to prevent overwriting of numbers by signing the card.

This CVV number or additional/other card verification/identification number may be used for transactions over the phone or the internet to provide card verification. Such transactions are called Card Not Present transactions. One problem with CVV numbers is that they can be easily read and copied by an unauthorized person who then can use the CVV number, along with the payment card number found on the front of the card and the card's expiration date, to make fraudulent payment card transactions. Card Not Present (CNP) payment card transactions experience a high level of fraud, and better security for CNP transactions is a continuing, long-felt need.

Payment card companies use many different names for card identification numbers other than CID or CVV numbers: card security code (CSC), card verification data (CVD), card verification number (CVN), card verification value (CVV or CVV2), card verification value code (CVVC), card verification code (CVC or CVC2), verification code (V-code or V code), card code verification (CCV), and signature panel code (SPC) are examples.

To mitigate fraud with such payment cards, the CVV, a PAN, a OTP (one time password), or other card identification number may be stored in memory on the card, and displayed, in digital form or otherwise, on a display screen that is on either the back or front of the card only after authentication/verification. This screen may be connected to a power source and to one or biometric sensors used to verify that the card user is authorized. The card may include an on/off switch or just an “on” switch to minimize power consumption, e.g., during non-use of the card. The authorized card user may, for example, touch a fingerprint sensor on the card, or hold the card in front of themselves to allow capture of biometric information that is then matched to authorized user biometric information stored on the card or may enter in a PIN number. Such authorization may then cause the CVV or other card identification number to be displayed, for a limited time or otherwise.

Following user authentication as a result of a match of biometric information or PIN number on the card to a user, the card then displays on its surface the card's stored CID, CVV, PAN, or other security identification number for a prescribed time period, allowing a user to use the card to carry out a transaction, whether CNP or otherwise. These new cards provide added security at a point of sale in a store or other place of business, as the security identification number is displayed following a biometric match of the user to the card. A merchant, for instance, may, in some cases, enter this identification number on its terminal/connected register at the time of making a transaction.

Alternatively, the PAN, CVV, or other identification number may be a constantly changing number that is synchronized, but not directly linked to a number generating system on a card issuer's computer system. This constantly changing number may be stored in/on card memory, then displayed on a card's display screen following a positive biometric match of a card user with the biometric data of the user on the card. The change may arise from passage of time, or upon occurrence of an event, such as a transaction.

The card may also display, on a screen on the card, a CID, PAN or OTP, which usually differs from the CVV or other security number. The CID, PAN or OTP is usually an unchanging number, but may a constantly changing number that is synchronized, but not directly linked to, a number generating system on a card issuer's computer system. This constantly changing number may be displayed on a card's display screen, for a limited time or otherwise, following a positive biometric match of a card user with the biometric data of the user on the card. Number changes may arise from passage of time, or upon occurrence of an event, such as a transaction.

PAN's are found on payment cards, such as credit cards and debit cards, on stored-value cards, gift cards and other similar cards. PAN's may have a prescribed internal structure, and a prescribed numbering scheme. Bank card numbers are prescribed by ISO/IEC 7812. Bank card numbers identify a card, which is then electronically associated by an issuer with a cardholder, and with a cardholder's bank account.

An ISO/IEC 7812 card number may include 16 digits, and may include up to 19 digits. Six of these digits are the Issuer Identification Number (UN) [previously called the “Bank Identification Number” (BIN)]. The first of these six digits is the Major Industry Identifier (MH), with a variable length, up to 12 digits, for an individual account identifier.

Access control cards, identity cards, or licensing cards may also include one or more electronically stored numbers, letters, or images or other card identification data/number that may be stored in memory on the card, and displayed, in digital form or otherwise, on a display screen that is on either the back or front of the card only after authentication/verification. This screen may be connected to a power source and to one or biometric sensors used to verify that the card user is authorized. The authorized card user may, for example, enter a PIN number, touch a fingerprint sensor on the card, or hold the card in front of themselves to allow capture of biometric information that is then matched to authorized user biometric information stored on the card. Such authorization may then cause such an identifier to be displayed, for a limited time or otherwise.

Following user authentication as a result of a match of biometric information on the card to a user, the card then displays on its surface the card's stored identifier for a prescribed time period, allowing a user to use the card to carry out a transaction. These cards provide added security at a point of sale in a store or other place of business, as the identifier is displayed following a biometric match of the user to the card.

Alternatively, the identifer may be a constantly changing number that is synchronized, but not directly linked to a number generating system on a card issuer's computer system. This constantly changing number may be stored in/on card memory, then displayed on a card's display screen following a positive biometric match of a card user with the biometric data of the user on the card. The change may arise from passage of time, or upon occurrence of an event, such as a transaction.

A rechargeable battery is provided on such cards to power their functions. Power for recharging such batteries from a source outside the cards may pass through a contact pad, e.g., a gold pad, on the cards. Such pads may be connected to a smartcard IC or other interface chip on, or embedded in such cards, or from a card reader into which such cards are inserted or to which such cards are touched, or by wireless transmission from a source outside such cards. The chips on/in such cards may be connected to a computer, circuit board, or power management system on such cards. A power management system on such cards, where present, may deliver power from outside such cards to power storing/consuming elements on such cards. User authentication may activate connection between such contact pads and IC's on such cards. Signals to a card's on board computer using an electronic switch, for example, may also be used to activate/deactivate connection between an IC chip on the card and the card's contact pad to control flow of information/data to/from a card.

Such smartcards may also comprise an on-board radio frequency receiver/transmitter/transceiver chip that is connected to an on-board antenna. Such cards may also then include an interference device between the antenna and the radio frequency chip to block flow of information and/or data between the radio frequency chip and the antenna. Such a device may be an attenuator or an electronic switch. The interference device may be deactivated upon user authentication/verification, allowing information/data to flow between the radio frequency chip and the antenna.

Information/data may be transmitted to/from memory/storage on such cards through the same or a different contact pad, wirelessly or otherwise.

Rechargeable batteries are also suitable for use on smart cards that may provide access to prescribed physical premises such as buildings and elevators, or that may deliver RFID or other wireless signals to computers, PDA's, security stations, or other areas of limited access, or to send alert messages/signals. Rechargeable batteries are also suitable for use on smart cards that may provide access to computer systems through contact readers connected to USB ports.

### BRIEF DESCRIPTION OF THE DRAWINGS

FIGS. 1 to 3 illustrate some embodiments of the cards of the invention, but the claims are not limited to these embodiments.

### DETAILED DESCRIPTION OF THE DRAWINGS

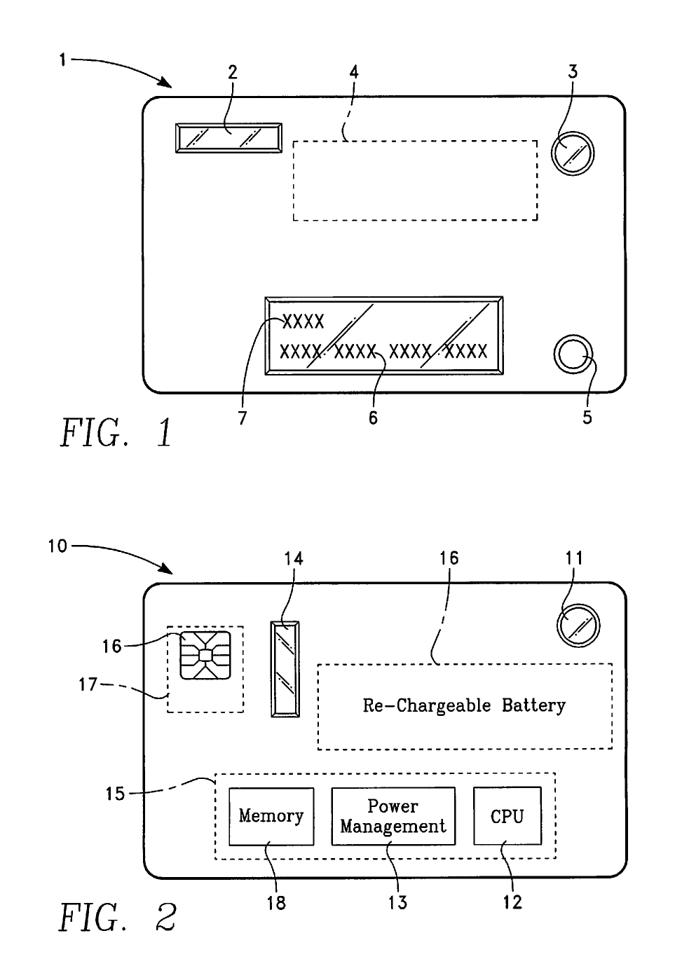

FIG. 1 shows payment transaction data card 1 with onboard fingerprint verification/authorization sensor 2 and image verification/authorization sensor 3, on/off switch 5, and display screen 6. Card 1 includes circuitry that includes, but is not limited to a processor chip, memory chip and rechargeable battery. To activate card 1, a user touches his fingerprint to sensor 2, and displays his or another designated image to sensor 3, and a processor in/on card 1 compares the user's print and the sensed image to a database, in memory on card 1, of stored, known images and prints. If a match to an authorized user's print and to the displayed image occurs, card 1 is activated, data can flow to/from card 1, and changing or unchanging identification data, such as a 3 or 4 digit security number 7, appears on screen 6.

The security number may change upon each occurrence of a prescribed event, or from passage of a prescribed time period, or both. Data card 1 may include a display screen for displaying user identification data stored thereon/therein after fingerprint, image or both fingerprint and image user verification/activation events. This security number must be used, as by entry into a card reader at a merchant location, to authorize a payment with card 1.

FIG. 2 shows contact smart card 10, with gold pad 16 placed over, and electrically connected to smart card chip/IC 17, by a plurality of wires/paths. One of these wires/paths includes a connect/disconnect electronic switch that is connected/activated after a successful biometric match between a user and card 10 using fingerprint sensor 14, as explained above. Upon such connection, electricity/data/information may flow to/from on-board CPU 12. CPU 12 is connected to on-board rechargeable battery 16, such that electricity may flow into card 10 through IC 17, which is connected to CPU 12, then to battery 16. Further, upon such connection, information/data may flow into card 10 to IC 17, to memory chip 18, which is part of on-board circuit board 16. Information/data may also pass from card 10′s memories to destinations outside card 10 through IC chip 17.

Circuit board 15 also includes power management chip 13, which controls delivery of power to some or all elements on card 10.

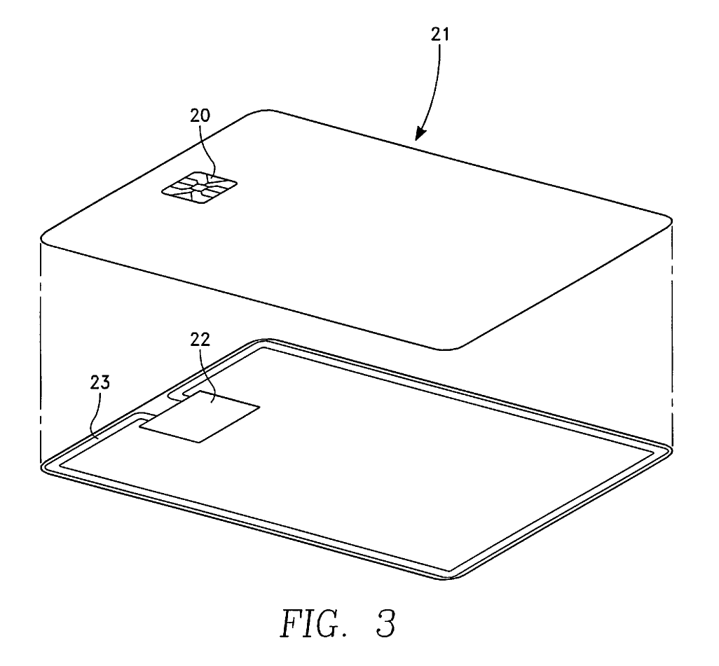

FIG. 3 shows contactless smart card 21 with gold pad 20 placed over IC chip 22 and antenna 23 connected to IC 22. Such a smart card may also include the other elements of the contact smart card depicted in FIG. 2. Antenna 23 provides an input path for data/information/electricity to card 21, and an output path for information/data from card 21 to destinations outside card 21. Antenna 23, IC chip 22, and gold pad 20 are connected by a plurality of wires/paths. One of these wires/paths includes a connect/disconnect electronic switch that is connected/activated after a successful biometric match between a user and card 21 using fingerprint sensor 14, as explained above. Upon such connection, electricity/data/information may flow to/from on-board CPU 12, and recharging electricity may pass to battery 13.

What is claimed is:

1. A smartcard that can connect, wirelessly or by contact, to a reader or to a computing device, mobile telephone or cellular telephone, said card permitting the flow of data to said card, from said card, or both, when connected to said reader or to said computing device, after fingerprint scanning authorization/user verification, PIN number authentication, and/or after image scanning authorization/user verification, said card optionally including a display screen for displaying information, data, or both, stored thereon/therein after fingerprint, image, and/or PIN Number, or fingerprint, PIN number and/or image user match causing a verification and subsequent activation, onboard fingerprint scanning authorization/user verification, an onboard image scanning authorization/user verification, and/or onboard PIN number authorization/user verification, said smart card including onboard memory, an onboard processor, and an onboard rechargeable battery.

2. The smart card of claim 1 wherein said card provides contactless information communication.

3. The smart card of claim 1 further comprising an identification number that changes after each said verification/activation.

4. The smart card of claim 1 further comprising an identification number that displays for a prescribed/predetermined time after said verification.

5. The smart card of claim 1 wherein said smart card includes a smartcard contact pad for connection to a power source outside said smart card and to a power management system on said smartcard, and to said rechargeable battery, said battery using said connection to draw power into said smart card's power management system for recharging said rechargeable battery.

6. The smart card of claim 5 wherein said display screen is on the front or back of said card for display of information or data after verification/activation.

7. The smart card of claim 5 further comprising an interface for wireless transmission of information/data from memory on said smart card to a destination outside said smart card, and vice versa.

8. The smart card of claim 7 that stores wirelessly received data in said onboard memory.

9. The smart card of claim 1 comprising both fingerprint scanning authorization/user verification, and image scanning authorization/user verification, and optionally, visual face scanning, match and verification using a camera embedded inside said smart card.

10. The smart card of claim 1 further comprising a smartcard chip including an onboard smartcard IC chip and a separate, on board smartcard contact pad connected thereto, including an electronic switch to open or close the connection between the smartcard chip IC and the smartcard contact pad upon successful user authorization/verification; and a connection between said fingerprint scanning authorization/user verification, or said image scanning authorization/user verification, and said onboard memory, said onboard processor, and said onboard rechargeable battery.

11. The smart card of claim 1 wherein said smart card is a contact card, or a contactless card, and includes a static, stored number selected from the group consisting of an identification number, a PAN, a CVV number, or an OTP, that is displayed on said display screen for a prescribed time period following successful authorization/verification, or a changing stored number selected from the group consisting of an identification number, a PAN, a CVV number, or an OTP, that is displayed on said display screen for a prescribed time period following successful authorization/verification, said changing number being synchronized, but not directly linked to, a number generating system on a computer system outside said smart card.

12. The smart card of claim 1 further comprising a camera inside said smart card that includes at least one of a card surface exposed lens, a wireless receiver with a connected antenna, and a wireless transceiver.

13. The smartcard of claim 1 further comprising an on-board radio frequency receiver/transmitter/transceiver chip that is connected to an on-board antenna and an attenuator or electronic switch between said radio frequency receiver/transmitter/transceiver chip and said antenna that blocks flow of radio frequency data between said chip and said antenna, and unblocks said flow upon successful user authentication/verification.

14. The smart card of claim 1 further comprising an on/off switch or an on switch.

15. The smart card of claim 1 further comprising a smartcard chip including an onboard smartcard IC chip and a separate, on board smartcard contact pad connected thereto, including an electronic switch to open or close the connection between the smartcard chip IC and the smartcard contact pad upon successful user authorization/verification.
